(19) United States
(12) Patent Application Publication
(10) Pub. No.: US 2026/0103069 A1
(43) Pub. Date: Apr. 16, 2026

(54) HYDROGEN FUELING SYSTEMS AND METHODS

(71) Applicant: Cummins Inc., Columbus, IN (US)

(72) Inventors: J. Steven Kolhouse, Columbus, IN (US); Lyle E. Kocher, Whiteland, IN (US); Jennifer Kay Light-Holets, Greenwood, IN (US)

(21) Appl. No.: 19/114,642

(22) PCT Filed: Sep. 20, 2023
(86) PCT No.: PCT/US2023/074669

§ 371 Date: Mar. 24, 2025

Related U.S. Application Data
(60) Provisional application No. 63/377,753, filed on Sep. 30, 2022.

(51) Int. Cl. B60K 15/063; B60K 15/03; F02D 19/06; G07C 5/08

(52) U.S. Cl. CPC B60K 15/063; F02D 19/0649; G07C 5/085; B60K 2015/03315

(57) ABSTRACT

Systems and methods and methods are disclosed for receiving, storing, using, and tracking hydrogen fuel from renewable and non-renewable resources to fuel a prime mover.

### CROSS-REFERENCE TO RELATED APPLICATION:

The present application claims priority to, and the benefit of the filing date of, U.S. Provisional Application Ser. No. 63/377,753 filed on Sep. 30, 2022, which is incorporated herein by reference.

### FIELD OF THE INVENTION

The present invention relates generally to fuel systems for prime movers, and more particularly is concerned with systems and methods for prime movers fueled with hydrogen.

### BACKGROUND

Hydrogen fuel can be produced from renewable or non-renewable resources. Renewable hydrogen gas can be made from renewable resources with zero greenhouse gas emissions, and may be referred to as “green” hydrogen. Green hydrogen is typically produced using clean electricity from energy resources such as wind or solar to electrolyze water. Electrolyzers use an electrochemical reaction to split water into its components of hydrogen and oxygen, emitting zero-carbon dioxide in the process.

Other hydrogen production processes result in non-renewable hydrogen gas, i.e. hydrogen produced using non-renewable energy sources and/or processes that result in greenhouse gas emissions. Non-renewable resources that may be used to produce hydrogen include, for example, natural gas, methane, black coal, lignite, and nuclear energy. These non-renewable resources may be employed in various production processes, such as steam reformation, gasification, electrolysis, methane pyrolysis, and fracking of naturally occurring deposits.

These non-renewable resources and associated production processes may have differing level of environmental impact, depending on the amount of greenhouse gases created in the production process and whether or not the greenhouse gases are captured. For example, hydrogen gas produced by natural gas through steam reformation in combination with carbon capture and storage and captured is considered to be low-emission hydrogen, while hydrogen gas produced through gasification of coal is high-emission hydrogen gas.

Environmental standards and goals for operating vehicles and equipment with prime movers such as engines and/or motors can vary widely from among owners, operators, regulatory bodies, jurisdictions, and other entities. Such standards may also vary over time and location. Operators may be penalized or rewarded for using fuel from renewable sources versus fuel from non-renewable sources. What is needed are systems and methods that allow owners and operators to effectively store, track, and use hydrogen fuel from renewable and non-renewable resources. Therefore, further contributions in hydrogen fueled prime movers are needed.

### SUMMARY

Systems and methods are disclosed for managing hydrogen fuel produced from various production processes that are then used to fuel a prime mover associated with a vehicle or piece of equipment. In one embodiment, renewable hydrogen fuel (i.e. hydrogen fuel produced from renewable energy resources) is stored in a first fuel tank and non-renewable hydrogen fuel (i.e. hydrogen fuel produced using non-renewable resources) is stored in one or more other fuel tanks. In one embodiment, the renewable hydrogen fuel and non-renewable hydrogen fuel are stored in and dispensed from separate fuel tanks. In one embodiment, the renewable hydrogen fuel and non-renewable hydrogen fuel are blended in one or more fuel tanks. The hydrogen fuel provided to, and the hydrogen fuel provided from, the one or more hydrogen fuel tanks and/or hydrogen fuel sources can be logged, tracked, controlled, and/or measured to achieve desired fuel usage and operational objectives.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic illustration of embodiment of a system that includes a prime mover and hydrogen fuel system.

FIG. 2 is a schematic illustration of another embodiment hydrogen fuel system.

FIG. 3 is a schematic illustration of another embodiment hydrogen fuel system.

FIG. 4 is a schematic illustration of another embodiment hydrogen fuel system.

FIG. 5 is a flow diagram of an embodiment of a procedure for operating a hydrogen fuel system.

FIG. 6 is a flow diagram of a further embodiment procedure for operating a hydrogen fuel system.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

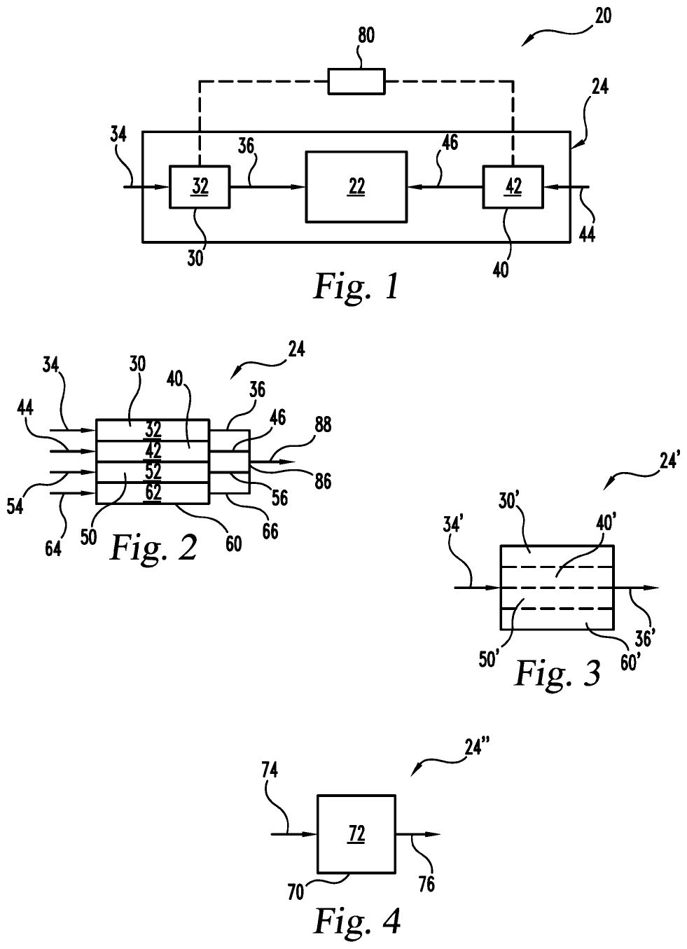

With reference to FIG. 1, a system 20 is shown that includes a prime mover 22 and a hydrogen fuel system 24. Hydrogen fuel system 24 includes a first fuel tank 30 for a first type of hydrogen fuel 32, and a second fuel tank 40 for storing a second type of hydrogen fuel 42. System 20 is shown in schematic form and may be an on-road vehicle, off-road vehicle, equipment, marine vessel, generator, or other device that is powered by prime mover 22. Prime mover 22 may be an internal combustion engine, motor, fuel cell, or combination thereof that is operable with hydrogen fuel to provide output power for use in operating system 20.

In an embodiment of hydrogen fuel system 24, the first type of hydrogen fuel 32 is a renewable hydrogen fuel and the second type of hydrogen fuel 42 is a non-renewable hydrogen fuel. As used herein, a renewable hydrogen fuel 32 is hydrogen fuel produced from renewable resources and may be referred to as “green hydrogen” (produced from wind or solar) or “yellow hydrogen” (produced from solar via electrolysis). For example, renewable hydrogen fuel 32 can be produced using clean electricity from renewable energy resources such that zero greenhouse gases are emitted in the production process. Non-renewable hydrogen fuel 42, on the other hand, is produced by processes from non-renewable resources and/or that result in at least some greenhouse gas emissions. Non-renewable hydrogen fuel 42 may be referred to as “blue hydrogen”, “gray hydrogen”, “pink hydrogen”, “brown hydrogen”, “black hydrogen”, and/or “turquoise hydrogen”.

In the arrangement of FIG. 1, the renewable hydrogen fuel 32 is stored in first fuel tank 30 separately from the non-renewable hydrogen fuel 42 stored in second fuel tank 40. This allows the type of hydrogen fuel to be used to power prime mover 22 to be logged, controlled, and tracked, as discussed further below. Other embodiments of hydrogen fuel system 24 such as shown in FIG. 2 include additional fuel tanks 50, 60, etc. Fuel tanks 30, 40, 50, 60, etc. may be provided for the separate storage and dispensing of different types of hydrogen fuel. For example, one fuel tank 30 may be for green hydrogen, one fuel tank 40 for blue hydrogen, one fuel tank 50 for gray hydrogen, and one fuel tank 60 for black or brown hydrogen. In this configuration, the usage, refilling, and/or replacement of the various hydrogen fuel types can be selectively employed and tracked. The additional fuel tanks 50, 60 may also or alternatively be used for storage of additional renewable hydrogen fuel 32 or for multiple tank storage of the same type of non-renewable hydrogen fuel.

In FIG. 1 first fuel tank 30 includes a first inlet 34 for receiving renewable hydrogen fuel 32 and a first outlet 36 connected to prime mover 22 to provide the renewable hydrogen fuel 32 thereto. Second fuel tank 40 includes a second inlet 44 for receiving non-renewable hydrogen fuel 42 and a second outlet 46 connected to prime mover 22 to provide non-renewable hydrogen 42 thereto. In an embodiment, the first inlet 34 is configured to inhibit placement of non-renewable hydrogen fuel into first fuel tank 30. For example, first inlet 34 can be smaller than second inlet 44 or otherwise configured so that only renewable hydrogen fuel dispensers can be placed into first inlet 34 and non-renewable hydrogen fuel dispensers cannot.

In an embodiment, the outlets 36, 46 are separately connected to prime mover 22 so that hydrogen fuel can provided from only fuel tank 30, only fuel tank 40, or a both to provide a blend of hydrogen fuels. In an embodiment, inlet 34 and/or inlet 44 may be omitted and the corresponding fuel tank 30, 40 is removed and replaced with a newly filled fuel tank 30, 40 to re-supply the associate hydrogen fuel type. The newly placed fuel tank 30, 40 can then be connected to the appropriate outlet 36, 46. In an embodiment, the outlets 36, 46 are uniquely configured so that they may only be engaged with the appropriate type of renewable or non-renewable hydrogen fuel tank 30, 40.

In the embodiment such as shown in FIG. 2, each of the outlets 36, 46, 56, 66 is connected to a common supply manifold 86, and an integrated outlet 88 is connected to the prime mover 22. The fuel tanks 30, 40, 50, 60 and/or outlets 36, 46, 56, 66 may include valves or other flow control device so that a selected hydrogen fuel type can be provided from one of the tanks 30, 40, 50, 60, or so that a blend of two or more hydrogen fuel types can be provided from two or more of the tanks 30, 40, 50, 60. Each of the fuel tanks 30, 40, 50, 60 includes an inlet 34, 44, 54, 64 so that the tanks can be re-filled with the correct hydrogen fuel type. Alternatively, tanks 30, 40, 50, 60 may not include an inlet but instead the entire tank is removed and replaced in order to re-supply the hydrogen fuel type associated therewith.

In another embodiment of hydrogen fuel system 24′ such as shown in FIG. 3, multiple fuel tanks 30′, 40′, 50′, 60′ are provided that are connected to a common inlet 34′ and a common outlet 36′. The fuel tanks 30′, 40′, 50′, 60′ can store different types of hydrogen fuel, and be in fluid connection with one another and/or common outlet 36′ to provide the desired hydrogen fuel type or desired blend of hydrogen fuel types. In another embodiment of hydrogen fuel system 24″ such as shown in FIG. 4, a single fuel tank 70 is provided that includes a single inlet 74 and a single outlet 76. Fuel tank 70 stores a blend of hydrogen fuel types 72 therein. The blend of hydrogen fuel types 72 may include a known proportions of renewable hydrogen 32 and one or more non-renewable hydrogen fuels 42, 52, 62, etc.

In any of the embodiments of FIGS. 1-4, a controller 80 such as shown in FIG. 1 can be provided with hydrogen fuel system 24 to track various parameters associated with the renewable hydrogen fuel 32 and one or more non-renewable hydrogen fuels 42, 52, 62, etc., or blended hydrogen fuel 72. The parameters may include, for example, the type of hydrogen fuel and the identification of the fuel tank in which the hydrogen fuel type is located. Another parameter may be a source of the hydrogen fuel, such as when and where the replacement tank was purchased and/or refilled. Another parameter may be a quantity of hydrogen fuel contained in the tank, an amount of hydrogen fuel used over time, and/or an amount of hydrogen fuel associated with a refill or replacement of the tank.

In certain embodiments of the hydrogen fuel systems 24 disclosed herein, controller 80 is structured to perform certain operations to control fueling of prime mover 22 from hydrogen fuel tanks 30, 40, 50, 60, 70, etc. to provide the desired operational outcomes. In certain embodiments, the controller 80 forms a portion of a processing subsystem including one or more computing devices having memory, processing, and communication hardware. The controller 80 may be a single device or a distributed device, and the functions of the controller 80 may be performed by hardware or instructions provided on a computer readable storage medium. The controller 80 may be included within, partially included within, or completely separated from an engine controller (not shown). The controller 80 is in communication with any sensor or actuator throughout the systems disclosed herein, including through direct communication, communication over a datalink, and/or through communication with other controllers or portions of the processing subsystem that provide sensor and/or actuator information to the controller 80.

Example and non-limiting elements in communication with controller 80 include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

One of ordinary skill in the art, having the benefit of the disclosures herein, will recognize that the controllers, control systems and control methods disclosed herein are structured to perform operations that improve various technologies and provide improvements in various technological fields. Without limitation, example and non-limiting technology improvements include improvements in hydrogen fuel systems, improvements in utilization of renewable and non-renewable hydrogen fuel to power a prime mover 22, improvements in emissions reductions from prime movers, and/or improvements in performance or operation of aftertreatment systems and/or components of prime movers. Without limitation, example and non-limiting technological fields that are improved include the technological fields of hydrogen fuel systems and related apparatuses and systems as well as prime movers that power vehicles and/or equipment including the same.

Certain operations described herein include operations to log, receive, record, interpret, and/or to determine one or more parameters. Logging, recording, interpreting, or determining, as utilized herein, includes receiving values by any method known in the art, including at least receiving values from a datalink or network communication, receiving an electronic signal (e.g. a voltage, frequency, current, or PWM signal) indicative of the value, receiving a computer generated parameter indicative of the value, reading the value from a memory location on a non-transient computer readable storage medium, receiving the value as a run-time parameter by any means known in the art, and/or by receiving a value by which the parameter can be calculated, and/or by referencing a default value that is interpreted to be the parameter value.

The schematic flow descriptions which follow provide illustrative embodiments of methods for managing and controlling hydrogen fuel systems 24, 24′, 24″ associated with a prime mover 22. The fuel system 24, 24′, 24″ may be controlled, depending on the embodiment, to provide a single hydrogen fuel type at a time from a single tank 30, 40, 50, 60; a blended hydrogen fuel from two or more tanks 30, 40, 50, 60; or a blended hydrogen fuel from a single fuel tank 70. Reference to fuel tanks 30, 40, 50, 60 is understood to also refer to fuel tanks 30′, 40′, 50′, 60′ unless noted otherwise or if the discussed embodiment refers to separate storage and dispensing of hydrogen fuel. Operations illustrated are understood to be exemplary only, and operations may be combined or divided, and added or removed, as well as re-ordered in whole or part, unless stated explicitly to the contrary herein. Certain operations illustrated may be implemented by a computer or controller apparatus embodiment of controller 80 executing a computer program product on a non-transient computer readable storage medium, where the computer program product comprises instructions causing the computer to execute one or more of the operations, or to issue commands to other devices to execute one or more of the operations.

Controller 80 can be connected to actuators, switches, valves, meters, sensors, readers, cameras, transmitters, receivers, or other devices associated with fuel tanks 30, 40, 50, 60, 70. Controller 80 is configured to provide control commands thereto that regulate the amount, timing and duration of the flows of the hydrogen fuel from fuel tanks 30, 40, 50, 60, 70. Controller 80 is also configured to receive information about the hydrogen fuel stored in and provided from each of the fuel tanks 30, 40, 50, 60, 70 from one or more data sources. Example data sources include, for example, re-fueling station computers, another computer or controller associated with prime mover 22 such as an engine control unit, tags (such as RFID tags) or codes (such as bar codes or quick response codes) provided on a fuel tank, a hydrogen fuel dispenser used to re-fill the fuel tank, a computer or network associated with a platoon or fleet manager, a computer server or network associated with a vehicle owner, and/or an intelligent transportation system computer network.

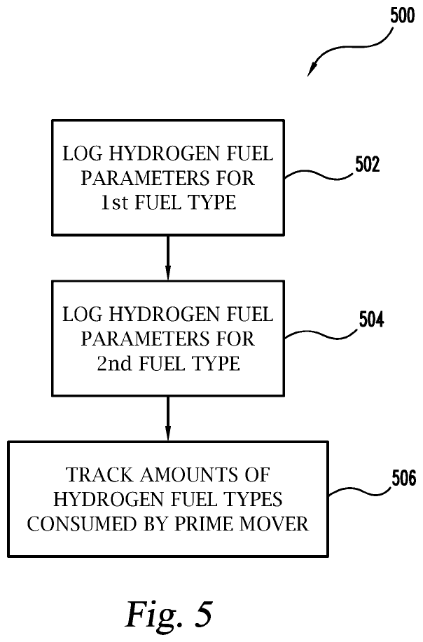

Referring to FIG. 5, one embodiment of a method 500 for fueling a hydrogen powered prime mover 22 is illustrated. Method 500 includes an operation 502 to log, in a controller 80 associated with the prime mover 22, one or more parameters associated with a first type of hydrogen fuel 32 stored in a fuel tank for use with the prime mover 22. Method 500 includes an operation 504 to log, in the controller 80, one or more parameters associated with a second type of hydrogen fuel 42 stored in a fuel tank for use with the prime mover 22. Method 500 includes an operation 506 to track, with the controller 80, the amount of the first type of hydrogen fuel 32 and the second type of hydrogen fuel 42 consumed by the prime mover 22 from the fuel tank or fuel tanks.

In an embodiment of the methods disclosed herein, the controller 80 is locally mounted on the vehicle or equipment powered by prime mover 22. In an embodiment of the disclosed methods, controller 80 is a computer server remote from the prime mover 22. In an embodiment of the methods disclosed herein, a combination of a local controller 80 and remote computer server is contemplated.

In an embodiment, the first type of hydrogen fuel 32 is stored in a first fuel tank 30 and the second type of hydrogen fuel 42 is stored in a second fuel tank 40. In an embodiment, the first fuel tank 30 and the second fuel tank 40 are installed on a vehicle associated with the prime mover 22. In an embodiment, the first fuel tank 30 and the second fuel tank 40 are each installed with the first type of hydrogen fuel 32 stored in the first fuel tank 30 and the second type of hydrogen fuel 42 stored in the second fuel tank 40. In an embodiment, the first fuel tank 30 is filled with the first type of hydrogen fuel 32 and the second fuel tank 40 is filled with the second type of hydrogen fuel 42 after the first fuel tank 30 and the second fuel tank 40 are installed on the vehicle. In any of the above embodiments, method 500 may include multiple non-renewable hydrogen fuel types 42, 52, 62 and associated fuel tanks 40, 50, 60 that are filled while on the vehicle or equipment, or are installed on the vehicle or equipment in a filled condition. In an embodiment, the method 500 includes a blended fuel tank 70.

In an embodiment of the method 500, logging the one or more parameters includes inputting the one or more parameters for each of the first type of hydrogen fuel 32 and the second type of hydrogen fuel 42 in the controller 80. In an embodiment, the one or more parameters for each of the first type of hydrogen fuel 32 and the second type of hydrogen fuel 42 are read from a tag or code associated with respective ones of with the first fuel tank 30 and the second fuel tank 40; from multiple fuel tanks 30, 40, 50, 60; or from a blended fuel tank 70. In an embodiment, method 500 includes receiving the one or more parameters for each of the first type of hydrogen fuel 32 and the other types of hydrogen fuel 42, 52, 62 from a dispenser or dispensers used to fill respective ones of with the fuel tanks 30, 40, 50, 60 or the blended fuel tank 70.

In an embodiment of method 500, the one or more parameters for each of the first type of hydrogen fuel 32 and the second type of hydrogen fuel 42 (and/or additional types of hydrogen fuel 52, 62) are received from a controller or a remote computer server/network associated with the prime mover 22. In an embodiment, the one or more parameters for each of the first type of hydrogen fuel 32 and the second types of hydrogen fuel 42, 52, 62 are received from a re-fueling station from which at least one the first type of hydrogen fuel 32 and the other types of hydrogen fuel 42, 52, 62 is obtained to re-fill the corresponding one of the first fuel tank 30 and the other fuel tank(s) 40, 50, 60, or blended fuel tank 70.

In an embodiment of method 500, one or more parameters for the first type of hydrogen fuel 32 includes a quantity and a source of the first type of hydrogen fuel 32.

The one or more parameters for the second type of hydrogen fuel 42 includes a quantity and a source of the second type of hydrogen fuel 42. These and other parameters for the hydrogen fuels 32, 42, 52, 62, 72 are also contemplated, such as a purchase price, purchase or re-fueling location, a proportion of hydrogen fuel types in a fuel tank, a usage amount of the various hydrogen fuel types over time, and/or an onboard level of each type of hydrogen fuel.

In an embodiment of method 500, an operator inputs or logs the hydrogen fuel parameters such as the fuel tank information and/or type, source, quantity, price, etc. for each of the hydrogen fuel types. The input can be manual, such as via a smart phone, tablet, application, software program, bar code reader, scanner, etc. In an embodiment, the vehicle or equipment is equipped with a bar code or QR code reader that detects such hydrogen fuel parameter data from a code on the fuel tanks or dispenser. In an embodiment, the fuel tank includes an RFID device or other tag that communicates the parameter data. In an embodiment, a remote computer server such as a fleet management service receives the hydrogen fuel parameter data and transmits it to the controller 80. Combinations of the above parameter logging techniques are also contemplated. The logged information can be recorded in controller 80 or a remote computer server, such as a fleet management computer or platoon computer. The parameter data can be transmitted using any suitable communication network or protocal, including WiFi, NFC, Bluetooth, ultra wide band network, internet, cloud, local area network, wide area network, Zigbee, EMV chips, etc.

In an embodiment of method 500, the types of hydrogen fuel dispensed into the one or more tanks is tracked by a sensor that detects a quality of the hydrogen fuel being dispensed. For example, the different types of hydrogen fuel may include a chemical marker or identifier that can be sensed to identify the associated hydrogen fuel type. The type of hydrogen fuel that is dispensed and/or consumed by operation of prime mover 22 can be sensed, logged, tracked and recorded by controller 80 and/or a remote computer server.

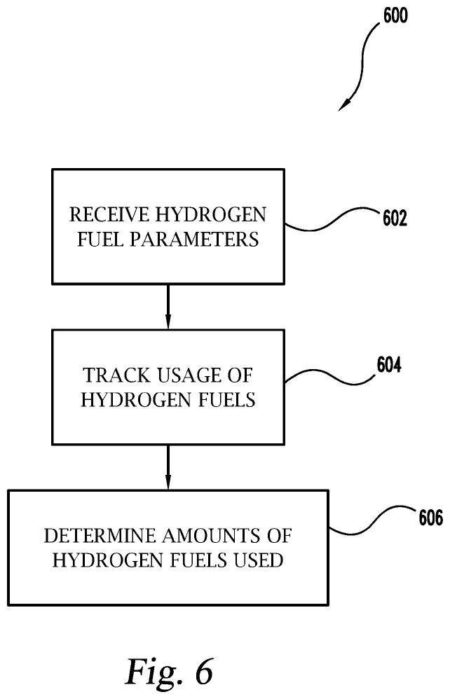

Referring to FIG. 6, another embodiment method 600 is illustrated for operating a hydrogen powered prime mover 22. Method 600 includes an operation 602 to receive one or more parameters associated with a renewable hydrogen fuel 32 and one or more non-renewable hydrogen fuels 42, 52, 62 to be used for operating the prime mover 22. Method 600 includes an operation 604 to track usage of the renewable hydrogen fuel 32 and the one or more non-renewable hydrogen fuels 42, 52, 62 during operation of the prime mover 22. Method 600 further includes an operation 606 to determine an amount of the renewable hydrogen fuel 32 and the one or more non-renewable hydrogen fuels 42, 52, 62 used by the prime mover 22.

In an embodiment, method 600 includes determining an amount of the renewable hydrogen fuel 32 and the non-renewable hydrogen fuel 42, 52, 62 supplied at a re-fueling event. Method 600 may further include determining a proportion of the renewable hydrogen fuel 32 and the non-renewable hydrogen fuel 42, 52, 62 blended in a fuel tank 70 after the re-fueling event. Method 600 may further include determining a cumulative proportion of the renewable hydrogen fuel 32 and the non-renewable hydrogen 42, 52, 62 fuel blended in the fuel tank 70 after the re-fueling event.

In an embodiment, method 600 includes determining a location, route, infrastructure, re-supply, and/or geo-fencing requirements associated with operation of the prime mover 22. Based on the location, route, infrastructure, re-supply, and/or geo-fencing requirements, method 600 includes selecting or prioritizing one of the renewable hydrogen fuel 32 and the non-renewable hydrogen fuel 42, 52, 62 for consumption by prime mover 22. In an embodiment, a plurality of fuel tanks 30, 40, 50, 60 are provided that are connected to the prime mover 22. At least one of the plurality of fuel tanks 30 stores the renewable hydrogen fuel 32 and each of the other of the plurality of fuel tanks 40, 50, 60 stores a different type of non-renewable hydrogen fuel 42, 52, 62.

In an embodiment, method 600 includes determining an amount of the renewable hydrogen fuel 32 and an amount of the non-renewable hydrogen fuel 42, 52, 62 for powering the prime mover 22 in the tanks 30, 40, 50, 60, 70. An availability of various fuel supplies capable of re-fueling with the renewable hydrogen fuel 32 and/or the non-renewable hydrogen fuel 42, 52, 62 may also be determined. Method 600 can further include prioritizing usage of the renewable hydrogen fuel 32 or the non-renewable hydrogen fuel 42, 52, 62 in response to the supply availability and types of hydrogen fuel available for re-fueling.

In an embodiment, the fueling from the first fuel tank 30 is controlled to provide the sole fueling with renewable hydrogen fuel 32 at certain operating conditions of prime mover 22, and fueling from one other of the fuel tanks 42, 52, 62 is controlled to provide the sole fueling with non-renewable hydrogen fuel 42, 52, 62 at other operating conditions of prime mover 22. In other embodiments, a blend of renewable hydrogen fuel 32 and one or more non-renewable hydrogen fuels 42, 52, 62 is provided to prime mover 22.

One embodiment of system 20 includes a hydrogen fuel system 24, 24′, 24″ with at least one renewable hydrogen fuel tank 30 to provide a first fuel renewable hydrogen fuel to prime mover 22 and at least one non-renewable hydrogen fuel tank 40, 50, 60 to provide non-renewable hydrogen fuel 42, 52,, 62 to prime mover 22 in addition to or in lieu of the renewable hydrogen fuel 32 under certain operating conditions. Controller 80 can provide fueling commands to provide fuel from one or more of tanks 30, 40, 50, 60, 70 according to prime mover operating conditions, quantity and/or availability of hydrogen fuel types, local restrictions on types of fuel usage, cost considerations, past usage of history of renewable and non-renewable hydrogen fuels by the prime mover 22, fleet considerations, and/or platoon considerations.

In an embodiment, controller 80 receives initial fuel information about the tanks 30, 40, 50, 60, and/or 70. The initial fuel information may include one or more fuel parameters, such as type of hydrogen fuel, source of the hydrogen fuel quantity of the hydrogen fuel, tank pressures, etc. Controller 80 monitors and tracks the cumulative amount of the hydrogen fuel types that are consumed by prime mover 22.

In an embodiment, controller 80 recognizes a re-fueling event, and receives information (type, source, quantity, etc.) on the incremental fuel that is supplied to one or more tanks 30, 40, 50, 60, 70. Controller 80 then recalculates blended fuel characteristic(s) for fuel tank 70 or if fuel tanks 30′, 40′50′60′ are employed. The blended fuel characteristics or cumulative usage amount may include, for example, the proportion of renewable hydrogen fuel 32 stored in the fuel system, allocation of fuel by source, etc.

Controller 80 then re-calculates, stores, and communicates the percentage or proportion of each fuel type that is consumed by prime mover 22.

In an embodiment, controller 80 prioritizes use of hydrogen fuel 32 from fuel tank 30 until renewable hydrogen fuel is no longer available. In an embodiment, controller 80 selects a fueling strategy for prime mover 22 that optimizes a cost to the operator of system 20 for consumption of hydrogen fuels 32, 42, 52, 62 versus the emissions created/environmental cost in producing the hydrogen fuel types 32, 42, 52, 62. In an embodiment, the amount of renewable hydrogen fuel 32 that is consumed during operation of prime mover 22 is tracked in order to provide credits, driver incentives, measure fleet statistics, fleet management, platoon management, etc.

As is evident from the figures and text presented above, a variety of aspects according to the present disclosure are contemplated. One aspect is a fuel system for a prime mover. The fuel system includes a first fuel tank including a renewable hydrogen fuel and a second fuel tank including a non-renewable hydrogen fuel. The first fuel tank includes a first outlet for supplying the renewable hydrogen fuel to the prime mover, and the second fuel tank includes a second outlet for supplying the non-renewable hydrogen fuel to the prime mover.

In an embodiment, the first fuel tank includes a first inlet for receiving the renewable hydrogen fuel and the second tank includes a second inlet for receiving the non-renewable hydrogen fuel, and the first inlet is configured differently than the second inlet to inhibit non-renewable hydrogen fuel from being placed into the first fuel tank.

In an embodiment, the first outlet and the second outlet are connected separately to the prime mover.

In an embodiment, the first outlet and the second outlet are connected to a fuel manifold, and the fuel manifold is connected to the prime mover.

In an embodiment, the fuel system includes a third fuel tank including an additional type of hydrogen fuel, the third fuel tank including a third outlet for supplying the additional type of hydrogen fuel to the prime mover.

In a further embodiment, the first outlet, the second outlet, and the third outlet are connected to a fuel manifold, and the fuel manifold is connected to the prime mover.

In a further embodiment, the first fuel tank includes a first inlet for receiving the renewable hydrogen fuel, the second tank includes a second inlet for receiving the non-renewable hydrogen fuel, and the third tank includes a third inlet for receiving the additional type of hydrogen fuel.

According to another aspect, a method for fueling a hydrogen powered prime move is provided. The method includes logging, in a controller associated with the prime mover, one or more parameters associated with a first type of hydrogen fuel stored with the prime mover for use by the prime mover; logging, in the controller, one or more parameters associated with a second type of hydrogen fuel stored with the prime mover for use by the prime mover; and tracking, with the controller, the amount of the first type of hydrogen fuel and the second type of hydrogen fuel consumed by operation of the prime mover.

In an embodiment, the first type of hydrogen fuel is a renewable hydrogen fuel stored in a first fuel tank and the second type of hydrogen fuel is a non-renewably hydrogen fuel stored in a second fuel tank.

In a further embodiment, the first fuel tank and the second fuel tank are located on a vehicle propelled by operation of the prime mover.

In a further embodiment, the first fuel tank is installed on the vehicle with the first type of hydrogen fuel stored in the first fuel tank and the second fuel tank is installed on the vehicle with the second type of hydrogen fuel stored in the second fuel tank. Additionally or alternatively, the first fuel tank is filled with the first type of hydrogen fuel while the first fuel tank is installed on the vehicle and the second fuel tank is filled with the second type of hydrogen fuel while the second fuel tank is installed on the vehicle.

In an embodiment, logging the one or more parameters includes one or more of: inputting the one or more parameters for the renewable hydrogen fuel and the non-renewable hydrogen fuel in the controller from an input device; reading the one or more parameters for the renewable hydrogen fuel and the non-renewable hydrogen fuel from a code associated with respective ones of with the first fuel tank and the second fuel tank; receiving the one or more parameters for the renewable hydrogen fuel and the non-renewable hydrogen fuel from a tag associated with respective ones of with the first fuel tank and the second fuel tank; receiving the one or more parameters for the renewable hydrogen fuel and the non-renewable hydrogen fuel from an engine controller associated with the internal combustion; and receiving the one or more parameters for the renewable hydrogen fuel and the non-renewable hydrogen fuel from a re-fueling station from which at least one of the renewable hydrogen fuel and the non-renewable hydrogen fuel is obtained to re-fill the corresponding one of the first fuel tank and the second fuel tank.

In an embodiment, the one or more parameters for the renewable hydrogen fuel includes a quantity and a source of the renewable hydrogen fuel, and the one or more parameters for the non-renewable hydrogen fuel includes a quantity and a source of the non-renewable hydrogen fuel.

According to another aspect, a method for operating a hydrogen powered prime mover is provided. The method includes receiving parameters associated with a renewable hydrogen fuel and a non-renewable hydrogen fuel to be used for operating the prime mover; tracking usage of the renewable hydrogen fuel and the non-renewable hydrogen fuel during operation of the prime mover; and determining an amount of the renewable hydrogen fuel and non-renewable hydrogen fuel used by the prime mover.

In an embodiment, the method includes determining an amount of the renewable hydrogen fuel and the non-renewable hydrogen fuel supplied at a re-fueling event.

In a further embodiment, the method includes determining a proportion of the renewable hydrogen fuel and the non-renewable hydrogen fuel blended in a fuel tank after the re-fueling event.

In a further embodiment, the method includes determining a cumulative amount of the renewable hydrogen fuel and the non-renewable hydrogen fuel blended in fuel tank used by the prime mover after the re-fueling event.

In an embodiment, the method includes determining a location of the prime mover; selecting one of the renewable hydrogen fuel and the non-renewable hydrogen fuel in response to the location; and fueling the prime mover with the selected one of the renewable hydrogen fuel and the non-renewable hydrogen fuel.

In an embodiment, the method includes determining an onboard quantity of the renewable hydrogen fuel and an onboard quantity of the non-renewable hydrogen fuel available for powering the prime mover; determining an availability of the renewable hydrogen fuel and the non-renewable hydrogen fuel for re-fueling; and prioritizing usage of the renewable hydrogen fuel and the non-renewable hydrogen fuel in response to the onboard quantities and availability of the renewable hydrogen fuel and the non-renewable hydrogen fuel for re-fueling.

In an embodiment, the method includes a plurality of fuel tanks connected to the prime mover, and one of the plurality of fuel tanks stores the renewable hydrogen fuel and each of the other of the plurality of fuel tanks stores a different type of non-renewable hydrogen fuel.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention.

Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A fuel system for a prime mover, the fuel system comprising:
a first fuel tank including a renewable hydrogen fuel, the first fuel tank including a first outlet for supplying the renewable hydrogen fuel to the prime mover; and
a second fuel tank including a non-renewable hydrogen fuel, the second fuel tank including a second outlet for supplying the non-renewable hydrogen fuel to the prime mover.

2. The fuel system of claim 1, wherein the first fuel tank includes a first inlet for receiving the renewable hydrogen fuel and the second tank includes a second inlet for receiving the non-renewable hydrogen fuel, and the first inlet is configured differently than the second inlet to inhibit non-renewable hydrogen fuel from being placed into the first fuel tank.

3. The fuel system of claim 1, wherein the first outlet and the second outlet are connected separately to the prime mover.

4. The fuel system of claim 1, wherein the first outlet and the second outlet are connected to a fuel manifold, and the fuel manifold is connected to the prime mover.

5. The fuel system of claim 1, further comprising:
a third fuel tank including an additional type of hydrogen fuel, the third fuel tank including a third outlet for supplying the additional type of hydrogen fuel to the prime mover.

6. The fuel system of claim 5, wherein the first outlet, the second outlet, and the third outlet are connected to a fuel manifold, and the fuel manifold is connected to the prime mover.

7. The fuel system of claim 5, wherein the first fuel tank includes a first inlet for receiving the renewable hydrogen fuel, the second tank includes a second inlet for receiving the non-renewable hydrogen fuel, and the third tank includes a third inlet for receiving the additional type of hydrogen fuel.

8. A method for fueling a hydrogen powered prime mover, the method comprising:
logging, in a controller associated with the prime mover, one or more parameters associated with a first type of hydrogen fuel stored with the prime mover for use by the prime mover;
logging, in the controller, one or more parameters associated with a second type of hydrogen fuel stored with the prime mover for use by the prime mover; and
tracking, with the controller, the amount of the first type of hydrogen fuel and the second type of hydrogen fuel consumed by operation of the prime mover.

9. The method of claim 8, wherein the first type of hydrogen fuel is a renewable hydrogen fuel stored in a first fuel tank and the second type of hydrogen fuel is a non-renewably hydrogen fuel stored in a second fuel tank.

10. The method of claim 9, wherein the first fuel tank and the second fuel tank are located on a vehicle propelled by operation of the prime mover.

11. The method of claim 10, wherein:
the first fuel tank is installed on the vehicle with the first type of hydrogen fuel stored in the first fuel tank and the second fuel tank is installed on the vehicle with the second type of hydrogen fuel stored in the second fuel tank; and/or
the first fuel tank is filled with the first type of hydrogen fuel while the first fuel tank is installed on the vehicle and the second fuel tank is filled with the second type of hydrogen fuel while the second fuel tank is installed on the vehicle.

12. The method of claim 9, wherein logging the one or more parameters includes one or more of:
inputting the one or more parameters for the renewable hydrogen fuel and the non-renewable hydrogen fuel in the controller from an input device;
reading the one or more parameters for the renewable hydrogen fuel and the non-renewable hydrogen fuel from a code associated with respective ones of with the first fuel tank and the second fuel tank;
receiving the one or more parameters for the renewable hydrogen fuel and the non-renewable hydrogen fuel from a tag associated with respective ones of with the first fuel tank and the second fuel tank,
receiving the one or more parameters for the renewable hydrogen fuel and the non-renewable hydrogen fuel from an engine controller associated with the internal combustion; and
receiving the one or more parameters for the renewable hydrogen fuel and the non-renewable hydrogen fuel from a re-fueling station from which at least one of the renewable hydrogen fuel and the non-renewable hydrogen fuel is obtained to re-fill the corresponding one of the first fuel tank and the second fuel tank.

13. The method of claim 9, wherein:
the one or more parameters for the renewable hydrogen fuel includes a quantity and a source of the renewable hydrogen fuel; and
the one or more parameters for the non-renewable hydrogen fuel includes a quantity and a source of the non-renewable hydrogen fuel.

14. A method for operating a hydrogen powered prime mover, the method comprising:
receiving parameters associated with a renewable hydrogen fuel and a non-renewable hydrogen fuel to be used for operating the prime mover;
tracking usage of the renewable hydrogen fuel and the non-renewable hydrogen fuel during operation of the prime mover; and
determining an amount of the renewable hydrogen fuel and non-renewable hydrogen fuel used by the prime mover.

15. The method of claim 14, further comprising determining an amount of the renewable hydrogen fuel and the non-renewable hydrogen fuel supplied at a re-fueling event.

16. The method of claim 15, further comprising determining a proportion of the renewable hydrogen fuel and the non-renewable hydrogen fuel blended in a fuel tank after the re-fueling event.

17. The method of claim 16, further comprising determining a cumulative amount of the renewable hydrogen fuel and the non-renewable hydrogen fuel blended in fuel tank used by the prime mover after the re-fueling event.

18. The method of claim 14, further comprising:
determining a location of the prime mover;
selecting one of the renewable hydrogen fuel and the non-renewable hydrogen fuel in response to the location; and
fueling the prime mover with the selected one of the renewable hydrogen fuel and the non-renewable hydrogen fuel.

19. The method of claim 14, further comprising:
determining an onboard quantity of the renewable hydrogen fuel and an onboard quantity of the non-renewable hydrogen fuel available for powering the prime mover;
determining an availability of the renewable hydrogen fuel and the non-renewable hydrogen fuel for re-fueling; and
prioritizing usage of the renewable hydrogen fuel and the non-renewable hydrogen fuel in response to the onboard quantities and availability of the renewable hydrogen fuel and the non-renewable hydrogen fuel for re-fueling.

20. The method of claim 14, further comprising a plurality of fuel tanks connected to the prime mover, and one of the plurality of fuel tanks stores the renewable hydrogen fuel and each of the other of the plurality of fuel tanks stores a different type of non-renewable hydrogen fuel.
